(19) United States
(12) Patent Application Publication
(10) Pub. No.: US 2017/0273253 A1
(43) Pub. Date: Sep. 28, 2017

(54) PLANTER KIT

(71) Applicant: Lawrence Yeh, Long Island City, NY (US)

(72) Inventor: Lawrence Yeh, Long Island City, NY (US)

(21) Appl. No.: 15/466,725

(22) Filed: Mar. 22, 2017

Related U.S. Application Data
(60) Provisional application No. 62/311,803, filed on Mar. 22, 2016.

(51) Int. Cl. A01G 9/02; A01G 27/00; G09F 1/06; A01G 9/04

(52) U.S. Cl. CPC A01G 9/02; A01G 9/042; A01G 27/005; G09F 1/06

(57) ABSTRACT

A planter kit may include a pan with a top surface and a wall extending upward from the top surface. A container may include a base and a wall extending upward from the base. At least one opening may be defined by the base. Multiple supporting members may be detachably coupled to the base. At least one of the supporting members may be tubular and configured to extend at least partially into the opening of the base of the container, thereby enabling fluid to pass from the container to the pan. At least one of the supporting members may include a horizontal support member. An object may provide external design to the container, and may rest on the horizontal support member. When a portion of the object rests on the horizontal support member, the portion is below the bottom surface of the base of the container and above the pan.

### RELATED APPLICATIONS

This application claims the benefit of, and priority to, co-pending U.S. Provisional Patent Application Ser. No. 62/311,803, filed on Mar. 22, 2016, the entire content of which is hereby incorporated by reference.

### FIELD OF THE INVENTION

The present disclosure relates generally to a planter, e.g., a container, or the like, as well as methods of using and manufacturing along with a decorative object.

### BACKGROUND OF THE INVENTION

Articles including expandable portions that “pop” to display three-dimensional objects are well known. The three-dimensional objects, however, are typically fixed to the article in permanent fashion.

Planters including pans to catch dripping water are also well known. However, planters are typically rigid and lack the ability to modify and transport without undue burden.

### BRIEF SUMMARY OF THE INVENTION

One embodiment of a planter kit may include a pan with a top surface and a wall extending upward from the top surface that prevents fluid from flowing out of the pan. A container may include a base and a wall extending upward from the base, where the base has a top surface and a bottom surface. At least one opening may be defined by the base. Multiple supporting members may be detachably coupled to the base of the container, and at least one of the supporting members may be tubular and configured to extend at least partially into the opening of the base of the container, thereby enabling fluid to pass from the container to the pan. At least one of the supporting members may include a horizontal support member. An object may provide external design to the container, and may be configured to rest on the horizontal support member. When a portion of the object rests on the horizontal support member, the portion is below the bottom surface of the base of the container and above the pan.

One embodiment of a process of manufacturing a planter includes forming a pan with a wall extending upward, forming a container with a base and a wall extending upward from the base, and forming at least one opening in the base of the container for allowing fluid to flow from the container. The process may further include forming a plurality of supporting members for inserting at least partially into the at least one opening of the base of the container, at least one of the supporting members may include a horizontal support member. At least one of the plurality of supporting members may be formed into a tube that allows fluid to pass from the container. An object may be formed to provide an external design to the container.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an illustrative planter kit in accordance with an embodiment;

FIG. 2 is a top perspective view of an illustration of the planter kit of FIG. 1;

FIG. 3 is a side perspective view of an illustration of the planter kit of FIG. 1;

FIG. 4 is a top perspective view of an illustration of the planter kit of FIG. 1;

FIG. 5 is an illustration of components of a planter kit;

FIG. 6 is an illustration of a pan of the planter kit of FIG. 1;

FIG. 7 is an illustration of an illustrative planter kit;

FIG. 8 is an illustration of a container of the planter kit of FIG. 1;

FIG. 9 is an illustration of supporting members of the planter kit of FIG. 1; and

FIG. 10 is an illustration of an expandable soil pellet of the planter kit of FIG. 1.

### DETAILED DESCRIPTION OF THE INVENTION

A mode of an embodiment is described in detail below. It should be noted that the following mode of an embodiment is an illustration to explain the embodiment and is not intended to limit the present invention solely to this mode of the embodiment. Furthermore, various modifications may be made as long as any such modifications do not depart from the essential point thereof. In addition, a person skilled in the art may employ modes of the embodiment in which the various elements described below are substituted with equivalent elements, and any such modes of the embodiment are also included in the scope of the present invention. Furthermore, positional relationships, such as up/down, left/right, which are indicated where used are based on the positional relationships illustrated in the drawings unless specifically stated otherwise. In addition, the proportions of dimensions of the various constituent elements in the modes of embodiment are not limited to the proportions of dimensions illustrated.

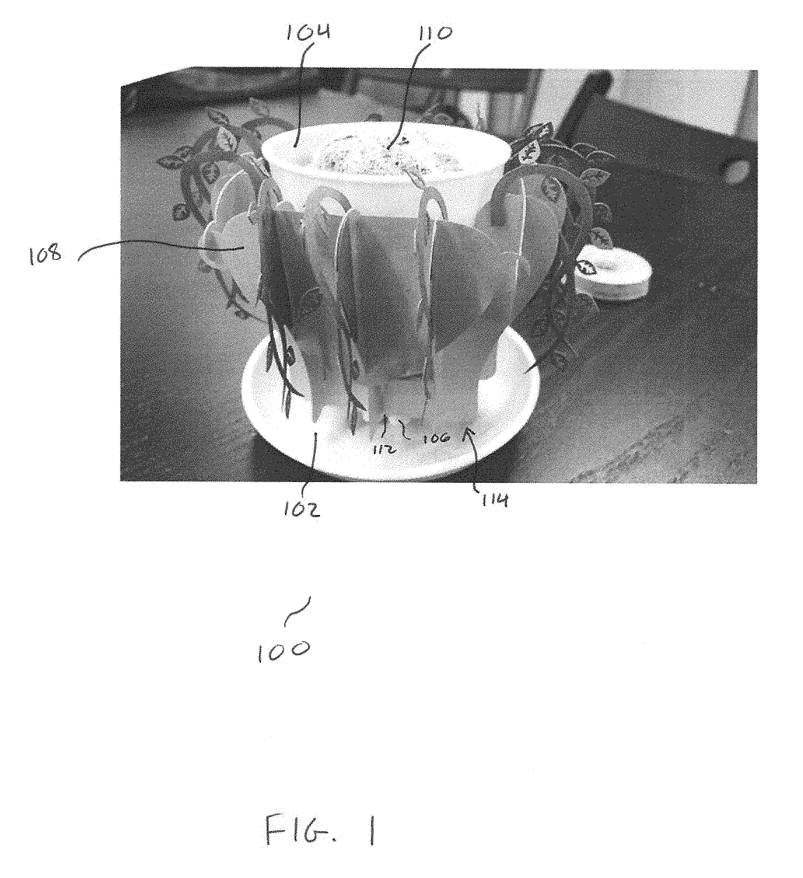

Referring now to FIG. 1, an illustrative planter kit 100 is shown. The planter kit 100 may include a pan 102, a container 104, a plurality of supporting members 106, and an object 108. The pan 102 is configured to hold the container 104. The supporting members 106 may be configured to be detachably coupled to the container 104. In an alternative embodiment, the the pan 102 may be an optional component of the kit 100.

In one embodiment, at least one of the plurality of supporting members 106 may include a tube for allowing a fluid, typically water, to pass from the container 104 to the pan 102. At least one of the supporting members 106 may include a horizontal support member 112. In an embodiment, each of the supporting members 106 may include a horizontal support member 112.

In one embodiment, the object 108 is configured to rest on the horizontal support member 112. When resting on the horizontal support member 112, a portion of the object 108 is below the container 104 and above the pan 102 with a gap 114 between the pan 102 and the object 108. The gap 114 prevents the object 108 from contacting fluid in the pan 102. The object 108 provides an external design to the container 104. In one embodiment, the planter kit 100 may further include an expandable soil pellet 110 that is configured to be placed in the container 104 and expand until a base soil layer is available for planting.

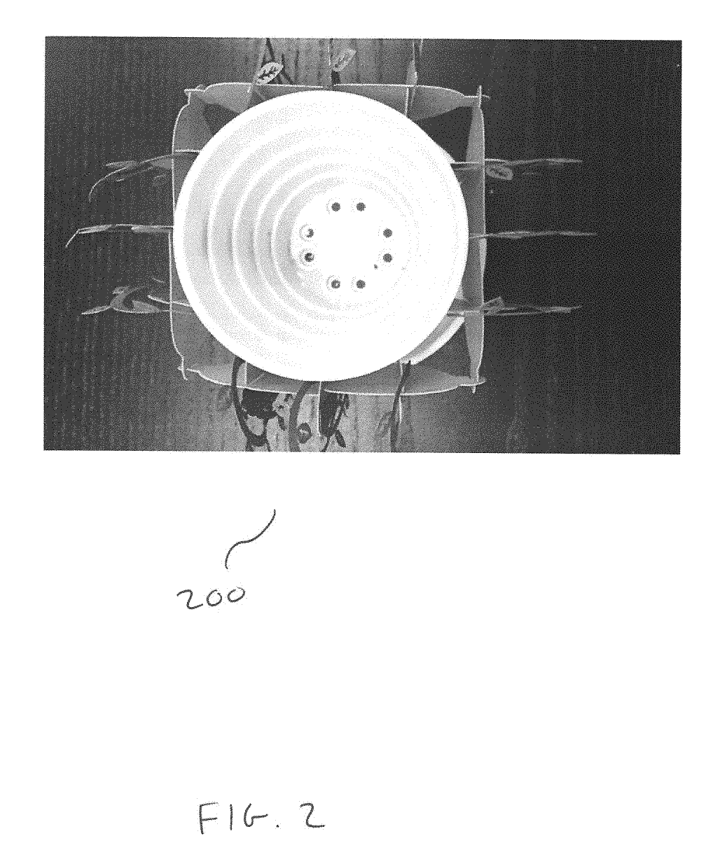

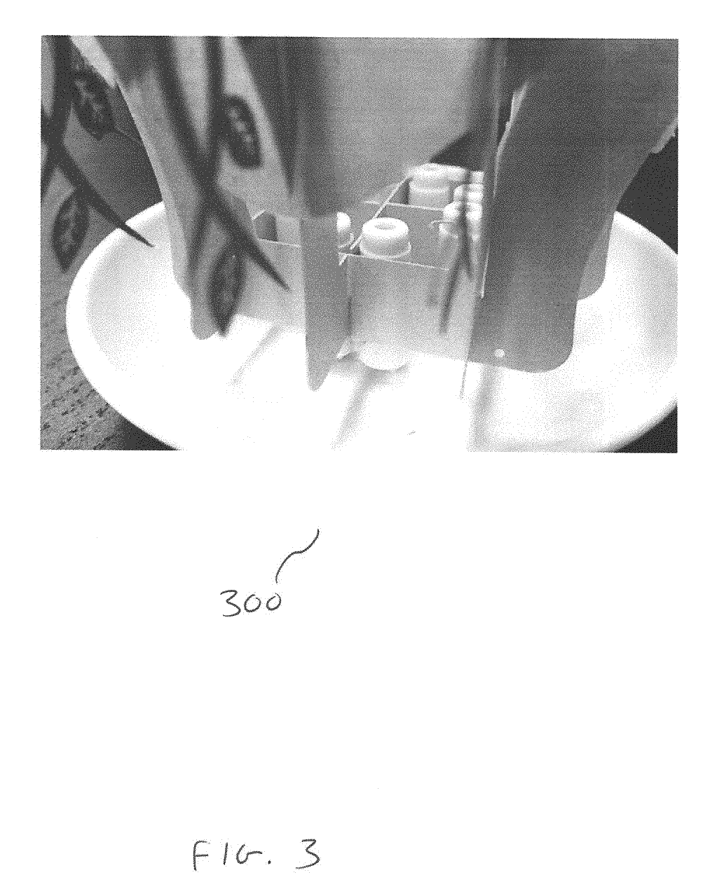

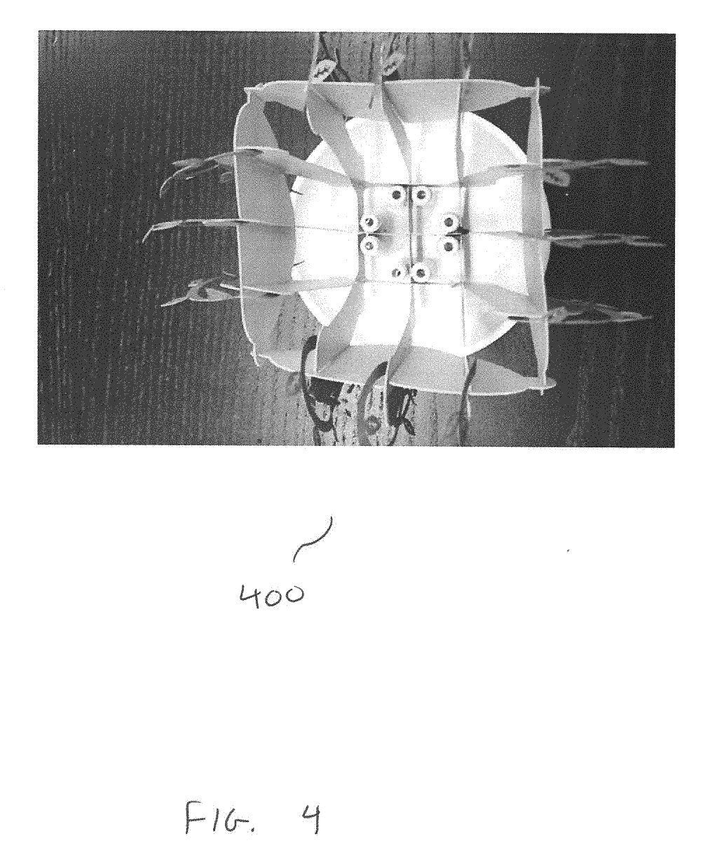

Referring now to FIG. 2, a top perspective view of an illustrative planter kit 200 is shown. Referring now to FIG. 3, a side perspective view of a planter kit 300 is shown. The planter kit 200 and planter kit 300 may be the planter kit 100 of FIG. 1. Referring now to FIG. 4, a perspective view of a planter kit 400 is shown. The container 104 of FIG. 1, is shown to be detached from the plurality of supporting members 106 of FIG. 1.

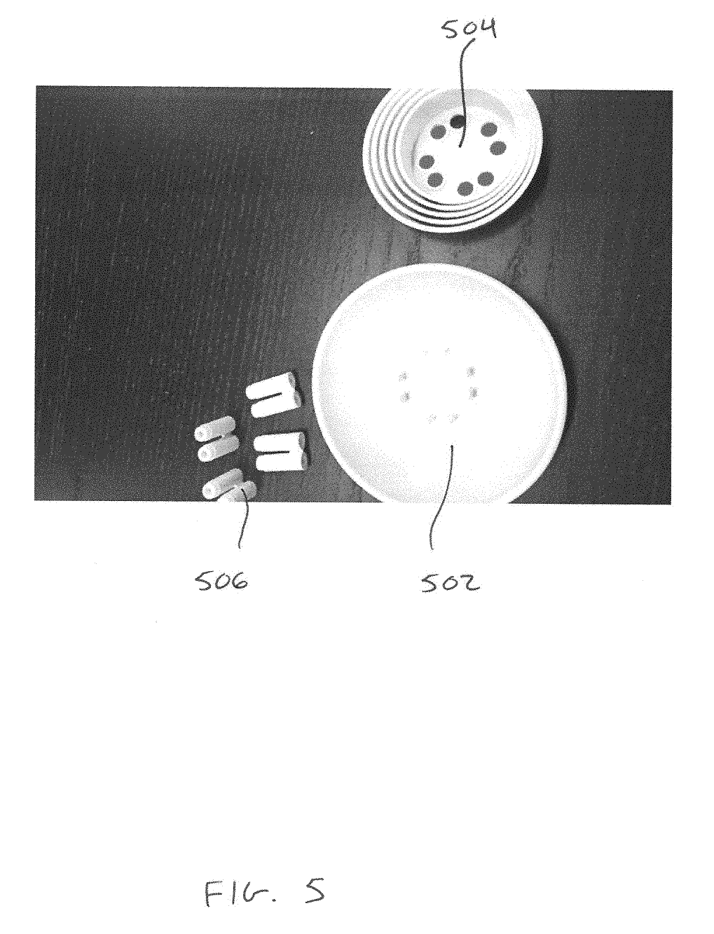

Referring now to FIG. 5, an illustration of illustrative components of an illustrative planter kit 500 are shown disassembled. A pan 502, a container 504, and multiple supporting members 506 are shown.

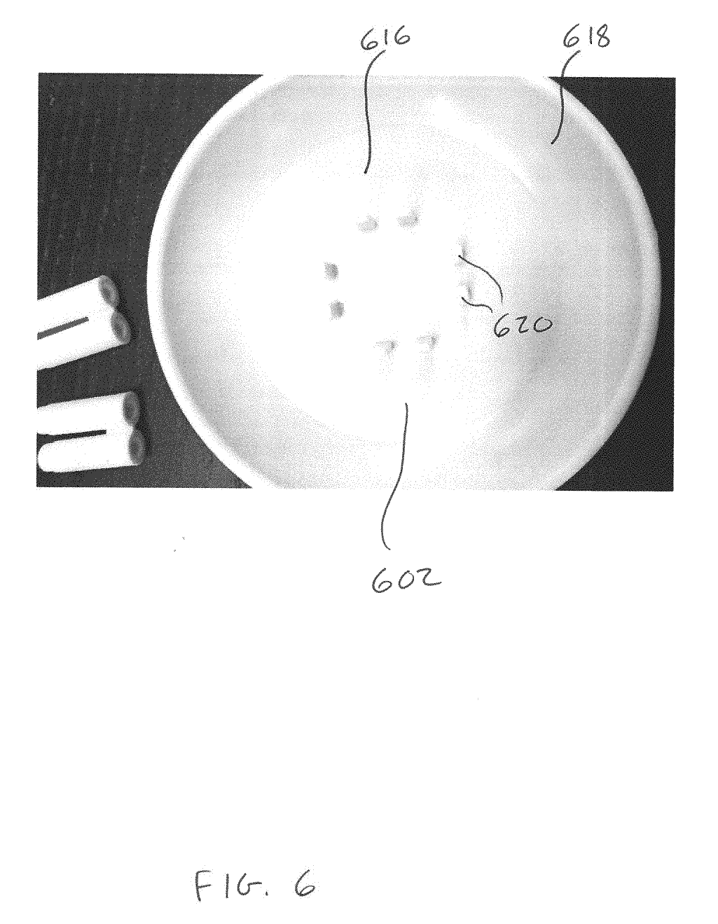

Referring now to FIG. 6, a pan 602 is shown. The pan 602 may be the pan 102 of the planter kit 100 of FIG. 1. The pan 602 may include a top surface 616 and a wall 618 extending upward from the top surface 616. In one embodiment, the pan 602 may further include a plurality of pegs 620. The pegs 620 are configured to extend upward from the top surface 616 of the pan 602. The pegs 620 are further configured to support the supporting members 106 of the planter kit 100.

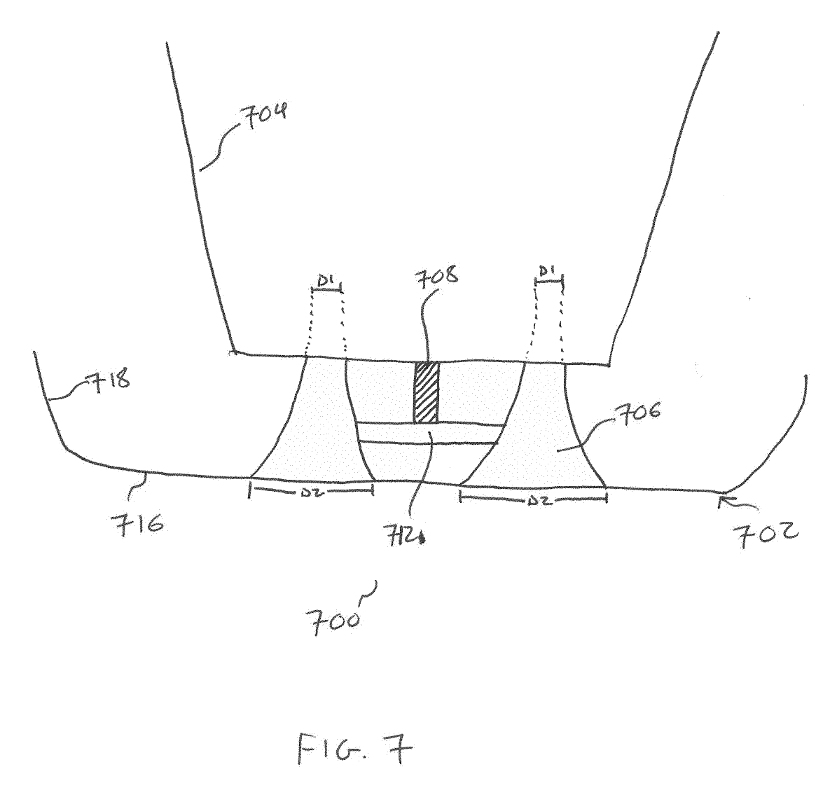

Referring now to FIG. 7, an illustrative planter kit 700 is shown. The planter kit 700 may include a pan 702 and a container 704. The pan 702 may include a top surface 716 and a wall 718 extending upward from the top surface 716. In one embodiment, the pan 702 may include multiple attached supporting members 706. The attached supporting members 706 may include a first end having a first diameter D1 and a second end opposite the first end having a second diameter D2. The first diameter D1 may be smaller than the second diameter D2 and openings of the container 704. The second diameter D2 may be larger than the openings of the container 704. The first and second ends of the attached supporting members 706 may cause walls of the attached supporting member 706 to be tapered. The tapered walls of the attached supporting members 706 may be configured to at least partially extend into the opening(s) of a base of the container 704. At least one of the attached supporting members 706 may include a tube, thereby enabling fluid to pass from the container 704 to the pan 702. At least one of the attached supporting member 706 may include a horizontal support member 712 for holding an object 708.

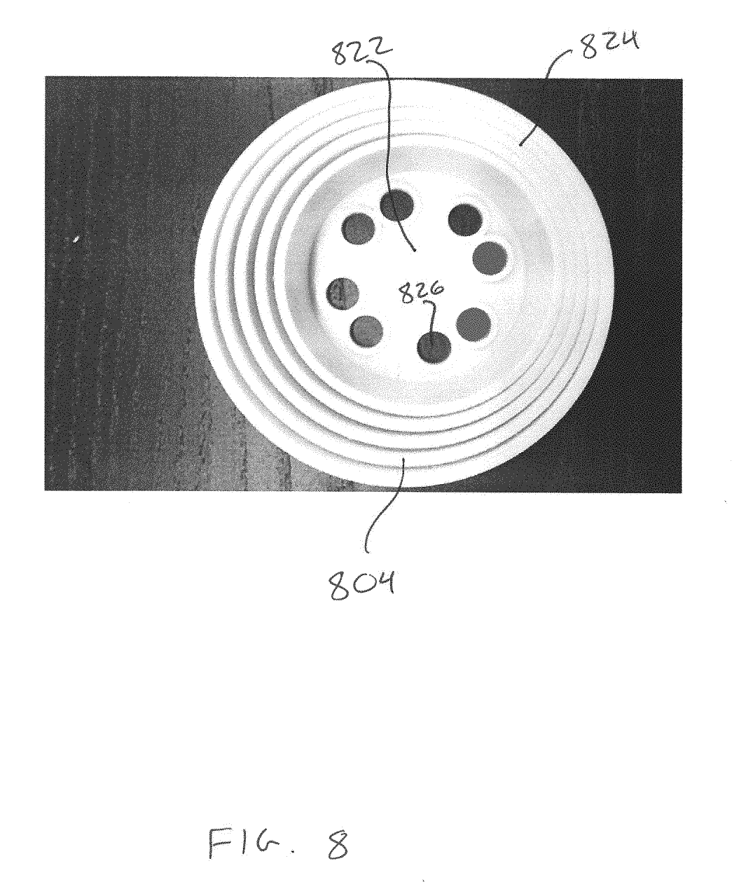

Referring now to FIG. 8, an illustrative container 804 is shown. The container 804 may be the container 104 of FIG. 1. The container 804 may include a base 822 and a wall 824 extending upward from the base 822. The base 822 may include at least one opening 826 that is defined by the base 822. The at least one opening 826 may allow fluid to pass from the container 804. In one embodiment, the container 804 may include a collapsible pot where the wall 824 is configured as a telescoping wall.

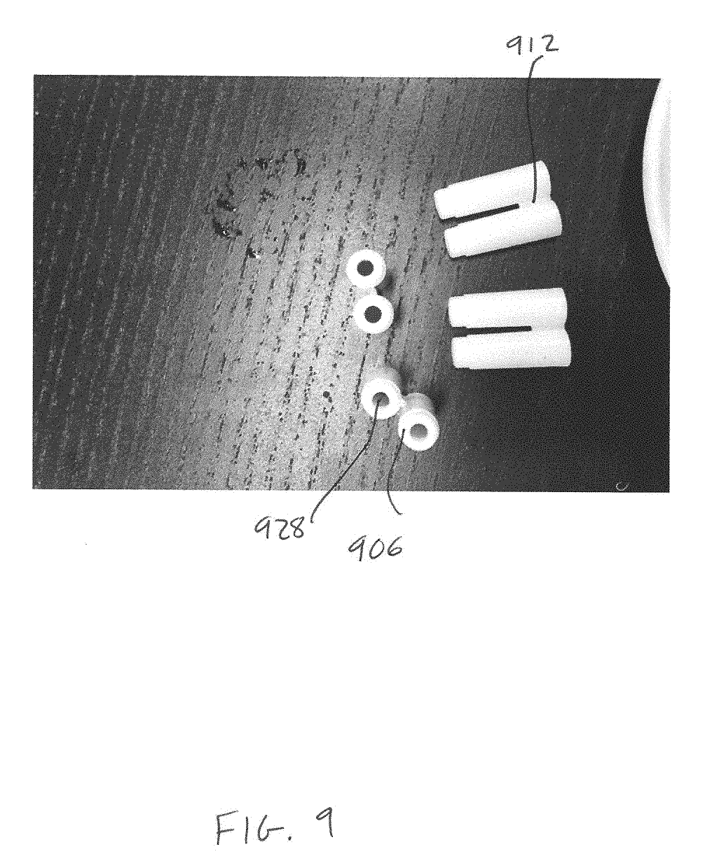

Referring now to FIG. 9, illustrative supporting members 906 are shown. The supporting members 906 may be configured to extend at least partially into the opening 826 of the container 804. At least one of the supporting members 906 may include an opening 928, thereby creating a tube. In some embodiments, the supporting members 906 are configured in pairs having a first supporting member and a second supporting member. The pairs may include a horizontal support member 912 interposed between the first supporting member and second supporting member. The horizontal support member 912 may be coupled to the first supporting member on a first side and coupled to the second supporting member on a second side opposite the first side. The horizontal support member 912 may be the horizontal support member 112 of FIG. 1.

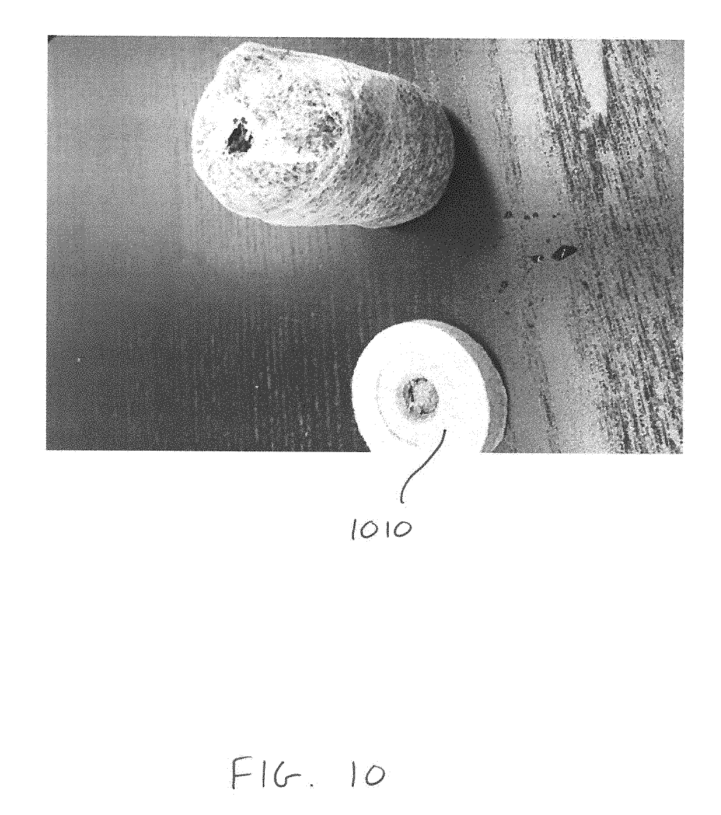

Referring now to FIG. 10, an expandable soil pellet 1010 is shown.

What is claimed:

1. A planter kit, said kit comprising:
a pan with a top surface and a wall extending upward from the top surface that prevents fluid from flowing out of the pan;
a container with a base and a wall extending upward from the base, the base having a top surface and a bottom surface with at least one opening defined by the base;
a plurality of supporting members detachably coupled to the base of the container, at least one of the plurality of supporting members being tubular and configured to extend at least partially into the opening of the base of the container thereby enabling fluid to pass from the container to the pan, at least one of the plurality of supporting members including a horizontal support member; and
an object that provides external design to the container that is configured to rest on the horizontal support member, that when resting on the horizontal support member is below the bottom surface of the base of the container.

2. The kit according to claim 1, wherein the container is a collapsible pot.

3. The kit according to claim 2, wherein the wall of the container is a telescoping wall.

4. The kit according to claim 1, wherein the plurality of supporting members are configured in pairs including a first supporting member and a second supporting member, the first supporting member being disposed substantially close to the second supporting member.

5. The kit according to claim 4, wherein the horizontal support member is interposed between the first supporting member and the second supporting member, the horizontal support member being coupled to the first supporting member on a first side and coupled to the second supporting member on a second side opposite the first side.

6. The kit according to claim 1, wherein the pan includes a plurality of pegs extending up from the top surface of the pan for coupling to the plurality of supporting members.

7. The kit according to claim 1, wherein the object is reconfigurable between a collapsed configuration and an expanded configuration.

8. The kit according to claim 7, wherein the article is detachably coupled to a greeting card.

9. The kit according to claim 1, wherein the plurality of supporting members having first ends having a first diameter and second ends opposite the first ends having a second diameter, the first diameter being smaller than the second diameter and the at least one opening of the base of the container, the second diameter being larger than the opening of the base.

10. The kit according to claim 9, wherein the plurality of supporting members are disposed on a sheet, the sheet configured to rest on the top surface of the pan interior the wall of the pan.

11. A method of manufacturing a planter, said method comprising:
forming a pan with a wall extending upward;
forming a container with a base and a wall extending upward from the base;
forming at least one opening in the base of the container for allowing fluid to flow from the container;
forming a plurality of supporting members for inserting at least partially into the at least one opening of the base of the container, at least one of the supporting members including a horizontal support member;
extruding at least one of the plurality of supporting members to form a tube for allowing fluid to pass from the container; and
forming an object for providing an external design to the container.

12. The method according to claim 11, wherein the forming the object includes conceptualizing a design of object and laser machining a material to from which the object will be formed.

13. The method according to claim 11, further comprising detachably coupling the object to a greeting card.

14. The method according to claim 11, further comprising forming pegs on the pan, the pegs disposed interior the wall of the pan.
